(19) United States
(12) Patent Application Publication
(10) Pub. No.: US 2015/0353118 A1
(43) Pub. Date: Dec. 10, 2015

(54) STEERING WHEEL WITH OPTICAL FINGER NAVIGATION MODULE

(71) Applicant: DAIMLER AG, Stuttgart (DE)

(72) Inventors: Volker ENTENMANN, Affalterbach (DE); Karsten GRANSE, Bad Liebenzell (DE)

(73) Assignee: Daimler AG, Stuttgart (DE)

(21) Appl. No.: 14/761,901

(22) PCT Filed: Dec. 21, 2013
(86) PCT No.: PCT/EP2013/003934

§ 371 Date: Jul. 17, 2015

(30) Foreign Application Priority Data
Jan. 19, 2013 (DE) 10 2013 000 927.8

(51) Int. Cl. B62D 1/04; G06F 3/02; G06F 3/042

(52) U.S. Cl. CPC B62D 1/046; G06F 3/042; G06F 3/0219

(57) ABSTRACT

A steering wheel for a motor vehicle is disclosed. The steering wheel has a first control module and a second control module. The first control module has an optical finger navigation module as a first control element and the second control module has a second control element. The first control element has an operating surface in a first plane and the second control element has an operating surface in a second plane, where the first plane is different from the second plane.

### BACKGROUND AND SUMMARY OF THE INVENTION

The present invention relates to a steering wheel for a motor vehicle with a first and a second control module, wherein the first control module has an optical finger navigation module as the first control element, and the second control module has a second control element, and wherein the first control element has an operating surface in a defined plane.

An operating device for a multi-function device in a motor vehicle is known from published document DE 10 2009 030 592 A1. The operating device has an actuation element comprising a touch-sensitive operating surface. A user is given haptic feedback during the operation of the multi-function device. This is caused by a specific support of the actuation element, by having the actuation element permit resettable shifting from an initial position in at least one degree of freedom. The shifting occurs, for example, by a perceptible mechanical pressure with a finger of the user on the actuation element. When the actuation element is pressed against the at least one switching element, the switching element is activated in the fitted and connected state and triggers an electrical signal that can be evaluated.

If several operating elements are arranged on the steering wheel, special actions are to be taken to prevent false activations. The driver of the motor vehicle should not have to depend on recognizing the operating elements optically, using his or her eyes. Instead, a correct operation of control elements of the steering wheel should also be possible when the driver does not avert his or her gaze from the road traffic.

The object of the invention therefore consists in proposing a steering wheel whose control elements can be operated more safely.

Thus, provided in accordance with the invention is a steering wheel for a motor vehicle with a first and a second control module, wherein the first control module has an optical finger navigation module as the first control element, the second control module has a second control element, and the first control element has an operating surface in a first plane, and wherein the second control element has an operating surface in a second plane that is different from the first plane, preferably in a second plane that is inclined relative to the first plane.

In an advantageous manner, the steering wheel has control elements whose operating surfaces are arranged in different planes which are preferably inclined relative to one another. In particular, the operating surface of an optical finger navigation module is different from the operating surface of another control element, e.g., of a button. Therefore, the driver can distinguish the different control elements or control modules haptically and reliably locate the optical navigation module.

Preferably, the first control module has a third control element which has a greater distance to the rotational axis of the steering wheel than the first control element. This means that the third control element on the steering wheel is further out radially than the first control element. When the thumb glides along the steering wheel edge inward to the optical control element, it may traverse the third control element, which lies further out. Since the optical control element lies radially inward, the probability that it will accidentally be traversed with the thumb is lower than in the case that the optical or touch-sensitive operating element lies outward.

The first and third control elements can essentially be arranged on a straight line which is moved parallel to a straight line through the rotational axis of the steering wheel. As a result, the control elements can, for example, be easily reached with the thumb. However, through inclination and/or positioning they can easily be distinguished from one another or from other control elements.

In particular, the third control element can comprise a button. Such buttons can be actuated perpendicularly by pressure on the operating surface, while the optical finger navigation module can be triggered or actuated as a touch-sensitive element by swiping along the operating surface. This also constitutes a haptic distinguishing characteristic.

In accordance with a further embodiment, an additional control module can be arranged on the steering wheel symmetrically to the first or second control module with respect to a plane through the rotational axis of the steering wheel. As a result of this, control modules on both sides of the steering wheel can be reached safely and reliably by the respective thumbs of the driver of the motor vehicle.

In addition, each of the control modules can have several control elements. As a result, it is possible to define function islands that the driver can easily reach and systematically separate in their function.

In addition, the first control element can be touch-sensitive. Thus, it is sufficient if the driver simply touches the operating surface of the control element to trigger an electrical signal.

In addition, the first control element can be designed to detect a movement of a finger of the driver of the motor vehicle. Therefore, in an advantageous manner, not only is a touch detected, but rather a movement is detected, converted into a control signal and evaluated.

It is particularly advantageous if a motor vehicle and in particular an automobile is equipped with the above described steering wheel.

The present invention will now be described in greater detail with the help of the attached drawings.

### BRIEF DESCRIPTION OF THE DRAWINGS

FIG. 1 shows a schematic representation of a steering wheel with optical finger navigation modules or OFN;

FIG. 2 shows a sketch of an operating movement in the case of several control elements;

FIG. 3 is a top view of control modules for a steering wheel;

FIG. 4 is a section through control modules from FIG. 3;

FIG. 5 shows a swiping movement for the operation of an optical finger navigation module;

FIG. 6 shows a further swiping movement perpendicular to the swiping movement from FIG. 5 and

FIG. 7 shows a pressing movement of a thumb for pressing a button.

### DETAILED DESCRIPTION OF THE DRAWINGS

The following exemplary embodiments described in greater detail constitute preferred embodiments of the present invention.

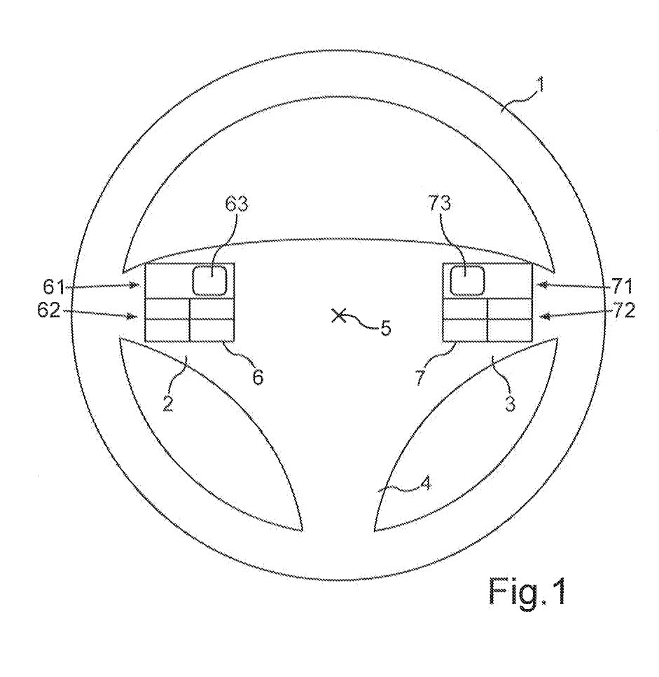

FIG. 1 shows a sketch of a steering wheel 1 in top view. Symbolically, the steering wheel 1 has three spokes 2, 3, 4 here. In addition, the steering wheel 1 can be rotated around a rotational axis 5. The rotational axis 5 forms the axis of a steering column not shown in the figure.

When driving straight ahead, the two spokes 2 and 3 run approximately horizontally. They each have an actuation device 6, 7, which is readily accessible with the respective thumb of the right and left hand of the driver. Each actuating device 6, 7 has one or more control modules 61, 62 and 71, 72.

In the example of FIG. 1, the respective first control module 61, 71 has a so-called “optical finger navigation module” or OFN 63, 73. The respective second control modules 62, 72 are symbolically divided into four fields here, which for example contain additional control elements. However, the division of the operating devices 6 and 7 in the present example are purely illustrative, and provision can be made for other divisions with different numbers of control modules and control elements.

In addition, the actuating devices 6, 7 or their optical finger navigation modules 63, 73 are arranged symmetrically to one another with respect to a plane through the rotational axis 5. In this case the plane in FIG. 1 runs vertically. However, the steering wheel does not have to be symmetrically designed. Instead, there can also be only one actuating device 6 or 7 or only one of the two actuating devices 6, 7 can be equipped with an optical finger navigation module 63, 73.

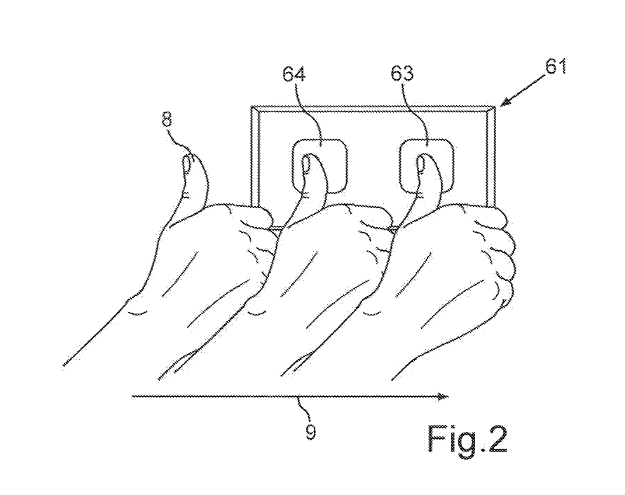

For example, if the first control module 61 has a button 64 or another mechanical operating or control element along with the OFN module 63 (e.g., button, switch, etc.), the typical thumb movement shown in FIG. 2 arises. The thumb 8 moves when the OFN module 63 lies further inward radially with respect to the rotational axis 5 of the steering wheel 1, i.e., is closer to the rotational axis 5 than the operating element 64 (here also referred to as the third control element), coming from the outside corresponding to the direction of movement 9 represented with an arrow in FIG. 2 via the operating element 64 to the OFN module 63. In the process, a brushing of the operating element 64 and in the end a desired operation (swiping) takes place via the touch-sensitive operating element (here OFN module 63).

If the touch-sensitive OFN module 63 were not arranged on the inside (i.e., the operating elements 63 and 64 were switched), then the outward lying touch-sensitive OFN module for the operation of the inside operating element 64 would be brushed by the thumb 8, which would trigger an operating error. Therefore it is advantageous if the touch-sensitive operating element ((MN module) on the steering wheel is further inside, since the thumb for actuating the operating elements is typically conducted from the outside to the inside.

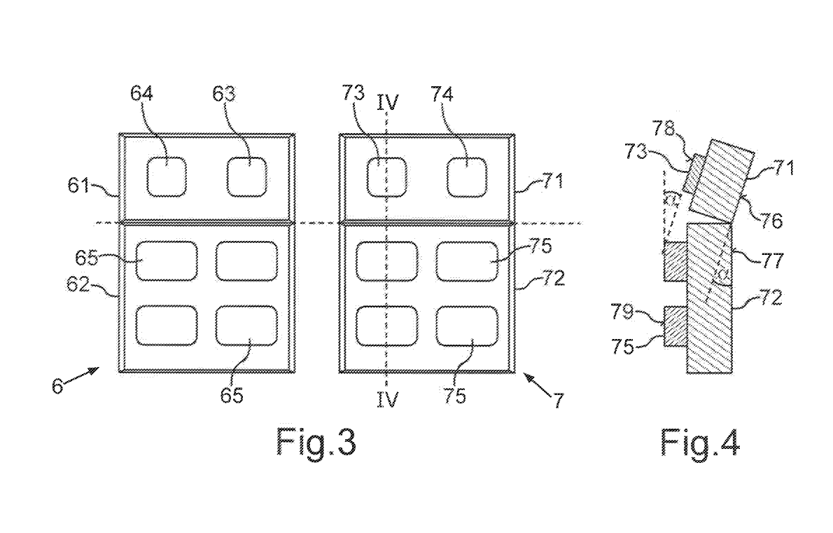

FIG. 3 shows a top view of the actuating devices 6 and 7. The respective equipping with control elements is again purely illustrative. However, it is essential that one or both of the actuating devices 6, 7 is divided into two control modules: A first control module 61 or 71 and a second control module 62 or 72. For purposes of presentation, the two actuating devices 6 and 7 are drawn directly next to one another.

In addition to the OFN module 63, which can be considered the first control element, the first control module 61 of the actuating device 6 for example also has a button 64, which can be considered as the third control element, as in the example of FIG. 2.

The second control module 62 arranged directly underneath the first control module 61 has four additional control elements 65 here, which could also be referred to as operating elements, for manual operation by the driver.

Similar to the sketch from FIG. 1, the actuating device 7 from FIG. 3 is symmetrically constructed here with respect to a plane running vertically between the two actuating devices 6 and 7 to the actuating device 6. Accordingly, the OFN module 73 lying inside in the first control module 71 of the right actuating device 7 and an outward lying operating or control element 74 are provided. The second control module 72 of the right actuating device 7 provided under the first control module 71 is likewise equipped with four operating or control elements 75, which in turn can be implemented as buttons, switches or the like.

A line of intersection IV is marked in FIG. 3. The corresponding section is shown in FIG. 4. It can be seen that the first control module 71 is arranged in a different plane from the second control module 72. The bottom 76 of the first control module 71 is inclined at a predetermined angle α (e.g., 10°, 20°, 30°, etc.) relative to the bottom 77 of the second control module 72. Since here the operating surface 78 of the OFN module 73 is parallel to the bottom 76 and the operating surface 79 of the control element 75 is parallel to the bottom 77 of the second control module 72, the operating surfaces 78 and 79 are inclined to one another by the angle α. However, what is essential is only the inclination of the two operating surfaces 78 and 79 to one another, because the driver can record this relative inclination haptically with his thumb. Thus, the first control module 71 can also be integrated with the second control module 72 in a single piece in a housing with a common bottom, and only the operating surfaces 78 and 79 are arranged in two different planes inclined to one another. Due to the inclination to one another, the driver can then distinguish the OFN module 73 from the control elements 75, as a result of which operating errors can be prevented.

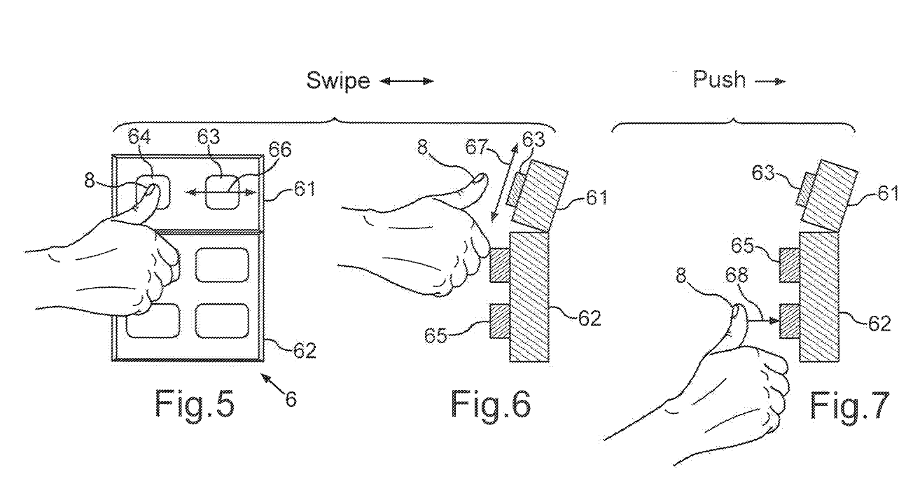

Due to the inclined operating surface, the driver can thus reliably locate the first control module 61 or 71 or its control elements haptically with his thumb. If he or she knows, in addition, that the inside control element of the first control module 61 is an OFN module 63, he or she will execute a swiping movement 66, for example in a radial direction, towards the steering wheel for reliable steering or navigation via the OFN module 63 in accordance with FIG. 5. As an alternative, the driver can also execute a swiping movement 67 in accordance with FIG. 6 with his or her thumb 8 in a circumferential direction of the steering wheel, i.e., perpendicular to the swiping movement 66, in order to carry out certain steering actions or navigation actions.

Since the driver can also reliably locate the second control module 62 haptically due to the inclination of the operating surfaces, he or she can also purposefully actuate one of the operating elements or control elements 65, for example by pressing in correspondence with the pressing movement 68 from FIG. 7. The probability of an operating error is thus reduced significantly, since the planes of the operating surfaces of the first control modules 61, 71 and of the second control modules 62, 72 are consciously separated from one another through inclination (compare horizontally running dashed line in FIG. 3). Thus, the driver can clearly differentiate the functional island with the operating elements 63 and 64 from the functional island with the operating elements 65.

1.-10. (canceled)

11. A steering wheel for a motor vehicle, comprising:
a first control module and a second control module;
wherein the first control module has an optical finger navigation module as a first control element;
wherein the second control module has a second control element;
wherein the first control element has an operating surface in a first plane;
wherein the second control element has an operating surface in a second plane;
and wherein the first plane is different from the second plane.

12. The steering wheel according to claim 11, wherein the second plane is inclined relative to the first plane.

13. The steering wheel according to claim 11, wherein the second control module is arranged on the steering wheel symmetrically to the first control module with respect to a plane through a rotational axis of the steering wheel.

14. The steering wheel according to claim 11, wherein the first control module has a third control element and wherein a distance of the third control element from a rotational axis of the steering wheel is greater than a distance of the first control element from the rotational axis of the steering wheel.

15. The steering wheel according to claim 14, wherein the first control element and the third control element are arranged essentially on a straight line which is parallel to a straight line through the rotational axis of the steering wheel or is moved parallel to the straight line through the rotational axis of the steering wheel.

16. The steering wheel according to claim 14, wherein the third control element is a button.

17. The steering wheel according to claim 11, wherein the first control element is touch-sensitive.

18. The steering wheel according to claim 11, wherein a movement of a finger of a driver of the motor vehicle is detectable by the first control element.

19. A motor vehicle that is equipped with the steering wheel according to claim [symbol]
